(19) United States
(12) Patent Application Publication
(10) Pub. No.: US 2013/0337117 A1
(43) Pub. Date: Dec. 19, 2013

(54) NUTRITIONAL FOOD PRODUCT AND METHOD OF PRODUCING A NUTRITIONAL FOOD PRODUCT

(71) Applicant: Dario Rolando MARTIN, Neuquen Capital (AR)

(72) Inventor: Dario Rolando MARTIN, Neuquen Capital (AR)

(21) Appl. No.: 13/917,065

(22) Filed: Jun. 13, 2013

(30) Foreign Application Priority Data
Jun. 13, 2012 (AR) 20120102095

(51) Int. Cl. A23L 1/302

(52) U.S. Cl. CPC A23L 1/302
USPC 426/72; 426/302

(57) ABSTRACT

A procedure for making a food product includes preparing a first mixture of dry ingredients including vitamins, proteins and additives; preparing a second mixture of liquid ingredients including water and a monosaccharide; preparing a third mixture in which a fat component is melted and is mixed with an emulsifier and a flavoring agent; preparing a fourth coating mixture that is solid at room temperature and includes fat components, vitamins, emulsifiers, and preservatives. The fourth coating mixture is melted to make a coating bath and the first, second and third mixtures are mixed to obtain a dough. The fourth coating mixture is poured over the mixture of the first, second and third mixtures.

### TECHNICAL FIELD

Certain embodiments of the present invention relate, for example, to current needs in the field of life and the production of food products.

### BACKGROUND

Methods for producing nutritional snacks often require cooking to achieve shelf-life stability or the shape integrity. This brings about the problem that, for instance, vitamins A, B, C and D, become unstable and disintegrate during cooking, resulting in bar with reduced nutritional value.

In U.S. Pat. No. 3,814,819, a bar consists of several baked crispy waffles, stacked one on top of the other, with a creamy filling in between them. The creamy filling contains added vitamins and minerals. Each portion provides 25% of the recommended daily amount of high-quality proteins, vitamins and minerals. The caloric content is about 200 to 250 calories per portion.

U.S. Pat. No. 3,434,843 refers to a food product containing a homogeneous distribution of the caloric and protein requirements. The snack contains an external continuous phase of front hydrophilic film, water and edible moisturizer. The external phase encapsulates an internal phase of fat component. The dispersion is stabilized by means of refrigeration or molding, followed by drying.

U.S. Pat. No. 3,058,828 describes an enriched food protein product to be used in survival situations, which includes 26 to 32% of non-fat solids of powder milk, sugar, chocolate flavor, and methyl cellulose. The vitamins and minerals for the food product are packaged separately from the food product.

U.S. Pat. No. 3,185,574 describes a baked snack, which contains enough hydrocarbons, proteins and fat to provide a balanced diet. The vitamins may be added during the cream forming or the cream mixing stage. Water is used as lubrication of the main dough.

U.S. Pat. No. 3,901,799 is related to a high protein chocolate snack containing 30 to 50% in chocolate weight. Caseinates and peanut butter are added to a mix of milk chocolate, black chocolate and cocoa butter, when the mixture is at a temperature between 80° F. and 100° F. The peanut butter and the caseinates are then mixed in the cast chocolate phase. The resulting product may be molded or extruded. Vitamins compatible with the components may be added.

U.S. Pat. No. 3,431,112 describes a nutritional food bar containing a binding agent, and which includes a fat component discontinuous phase, encapsulated by continuous water and hydrophilic film former phase. Lactose may be added to the first film. The product is shaped by means of pressure molding.

U.S. Pat. No. 4,543,262 is related to a process to obtain a snack or bar, which, even though does not need cooking, is based on a minimum amount of dairy products, with the purpose of being especially suitable for people suffering allergies to said products.

### DISCLOSURE

An embodiment of a method of producing a food product enable one to obtain a food product such as a snack that is based on a blend of nutritionally balanced food, in percentages of hydrocarbons, protein and fat, according to the nutritional pyramid, and fortified with vitamins and minerals. For example, 4 snacks or portions per day plus water intake may substitute a recommended 2,000 kcal diet.

In an embodiment, the combination of food produced offers a mix of amino acids that, per protein gram, reach and exceed the needs of children between 2 to 5 years old, 5 to 12 years old, and adults.

In an embodiment, this combination of components is nutritionally balanced in the percentages of hydrocarbons, proteins, and fat, according to the Food and Agriculture Organization's (FAO) nutritional recommendations. For example, one portion may substitute a meal.

In an embodiment, the snack structurally includes an inner or central part covered by an external or outer part that contains hydrogenated fat in order to maintain the organoleptic features of the product during its shelf-life.

In an embodiment, a mixture of liquid ingredients, hydro soluble solids, non-hydro soluble solids, and fat is carried out in mixing equipment, which also generates a great cutting effort. Mixing is performed until obtaining a homogeneous mixture. The dough may be laminated between rolls turning in an inverse manner. On conveyors, the laminate passes through a cold tunnel so that the dough becomes consistent and cutting is possible. The portions or snacks are coated with a mixture of cast fat and with other components similar to a bakery bath. The portions go through a second cold tunnel, and are packaged in flow pack and modified atmosphere. The process does not require cooking and prevents the destruction of thermolabile vitamins.

In an embodiment, the food mixture provides a combination and ratio of essential amino acids, which, according to the amino acid calculation, adjusted by digestibility, the gram of protein reaches and exceeds the needs of children from 2 to 5 years old, 5 to10 years old, and adults.

In an embodiment, a method of producing a food product enables one to obtain a food product such as a snack which is optimum for the use in different fields which include, for example:
Armies in war situations and under extreme temperatures.
Sports persons in survival situations.
Populations under a malnutrition risk, due to climatic or any other nature disaster.
Populations in regions affected by malnutrition problems.
For daily and regular consumption of any type of population or social class.
Etc.

### DETAILED DESCRIPTION OF EMBODIMENTS

Embodiments of the present invention include a method of producing a nutritional food product, which comprises a series of stages, through which, on the one hand, a first mix of dry ingredients is made including vitamins, proteins and additives; then, a second mixture of liquid ingredients is made comprising water and a monosaccharide; and then, a third mixture is made in which a fat component is melted at low temperature and is mixed with an emulsifier and a flavoring agent; on the other hand, a fourth coating mixture is made, which is solid at room temperature, comprising fat components, vitamins, emulsifiers, and preservers, and which is melted to make a coating bath; afterwards, the first, second, and third mixtures are mixed until obtaining a malleable structure dough that is non-sticky, chewable, and consistent, and has low relative moisture content; then, the dough obtained is poured on a production line and is subject to lamination, cooling, and fractionation; then, a coating bath is poured on the snacks resulting from the fractionation, and the, finally, they are subject to cooling and packaging.

In particular, in an embodiment, a method of producing a food product comprises a stage in which a first mixture of dry ingredients is made comprising protein and hydrocarbon sources, nutritional supplements, additives and vitamins, including one or more ingredients able to lower the water activity (WA). In an embodiment, the dry components comprise sodium caseinate, corn starch, powder whole milk, malto-dextrin, sodium glutamate, potassium sorbate, and a vitamin complex.

A second mixture of liquid ingredients is also made. The liquid ingredients comprise water—as solution solvent—and a monosaccharide. In an embodiment, the liquid ingredients comprise water, salt, sugar and glucose. The salt and sugar are dissolved in water, and the dissolution obtained in this manner is mixed with the glucose to form only one phase.

A third mixture is also made. In the third mixture a source of fat matter is melted at low temperature and is mixed with an emulsifier/stabilizer and a flavoring agent. In another embodiment, an alternative cocoa butter fat is used, such as a cocoa butter substitution fat (CBS). This fat is melted at a temperature that preferably does not exceed 40° C. and then is mixed with ammonium phosphatide and a flavoring agent (for instance, a fried onion flavor).

A fourth coating mixture is made which is solid at room temperature. The fourth coating mixture comprises components that include sources of fat matter, proteins and hydrocarbons, nutritional supplements, emulsifiers/stabilizers, vitamins and preservatives, including one or more components able to reduce the water activity.

In an embodiment, this coating mixture comprises an alternative cocoa butter fat (for example, a cocoa butter substitute fat [CBS]), powder whole milk, peanut, sodium caseinate, corn starch, lactose, malto-dextrin, saccharose, sodium chloride, a vitamin complex, ammonium phosphatide and sodium benzoate. This mixture is subject to heat until making a suitable melt to produce a coating bath, which, once cooled, is solid at room temperature.

In an embodiment, the coating mixture is subject to heat at a temperature of about 40° C. in a bathing device. In another embodiment, after mixing the ingredients of the coating mixture, and prior to its placement into the bathing device, the coating mixture is subject to refining and conching operations.

Then, the first mixture of solid ingredients, the second mixture of liquid ingredients, the third mixture and also the glycerin are mixed, until obtaining a malleable dough which is non-sticky, chewable and consistent, with low relative moisture content.

Afterwards, the dough obtained is poured into a production line, wherein it is subject to lamination, is cooled and fractioned—for instance by means of cuts—, until obtaining a food product or snack having a pre-determined size.

Then, the food products or snacks obtained in the previous stage are subject to a coating bath with the previously obtained fourth coating mix. In an embodiment, after the fractionation stage of the dough component of the snack inner part, the resulting snacks are passed under a bathing device placed above the production line. At the exit of the production line sector where the coating bath is carried out, there is a second cooling device that leaves the coating in a solid state.

The already finished snacks are finally packed, which may include, for example, their arrangement into different containers, their wrapping up, packaging or any other packaging suitable for their transport, storage, and for distribution to consumers.

In an embodiment, to perform the mixing operations, the use of double “Z” mixers has been considered.

Chart of components and their functions

| Component | Function |
|---|---|
| Glucose | Source of hydrocarbons; it reduces the WA, |
| | binding the free water and helps with texture. |
| Sodium | Source of proteins, fat emulsification, and it |
| Caseinate | helps with adhesion and firmness. |
| Native corn | Source of Hydrocarbons; it lowers the WA |
| starch | binding the free water and is a thickener and |
| | gelling agent, helping with texture. |
| CBS (cocoa | (e.g., APOKOL CM80) Source of fat matter, it |
| butter substitute | provides palatability and the suitable consistency. |
| fat) | |
| Leche entera | Economical nutritional supplement, rich in fatty |
| en polvo | acids, proteins, lactose, and calcium. |
| Peanut | Economical nutritional supplement, rich in natural |
| | antioxidant components, such as resveratrol, |
| | phytosterols, flavonoids and Vitamin E. |
| Water | It is the solvent of the solutions, the basis of |
| | the suspensions and the gel continuous phase. |
| Malto-dextrin | Source of Hydrocarbons; it provides the soft |
| | structure and the characteristic malleability of |
| | the product. |
| Sugar | Economical source of hydrocarbons; it decreases |
| (Saccharose) | the WA binding the free water. |
| Glycerin | Substitute of fat and sugars; it reduces the WA |
| | and provides body and palatability. |
| Salt (NaCl) | It offers the characteristic salty taste. |
| Vitamin | Vitamin and Mineral complex |
| Complex QD-1 | |
| Ammonium | Favors the product consistency, because it is a |
| Phosphatides | stabilizer and emulsifier |
| Monosodium | It potentiates flavor which balances, combines |
| Glutamate | and highlights the nature of other flavors. |
| Fried onion | It is a flavoring agent |
| flavor | |
| Sodium Benzoate | It is a preservative. |
| Potassium | It is a preservative. |
| Sorbate | |
| Synthetic ponceau | It is a dye. |
| red dye 4R | |
| Caramel | It is a dye. |
| natural dye | |

### Food Product:

Embodiments of the food product or snack may have different shapes (e.g., rectangular, triangular, round, bar-shaped, etc.). For example, a salty snack coated with a coating similar to a bakery bath structure. The ratio Core/Coating may be 75/25% (preferably, non-excluding, and within a ±20% tolerance), respectively.

With regard to the composition, the core may comprise the following components: glucose, sodium caseinate, corn starch, a cocoa butter substitute fat (CBS), powder whole milk, peanut, water, malto-dextrin, sugar, glycerin, salt, a vitamin complex, ammonium phosphatide, sodium glutamate, flavoring agent, potassium sorbate, and dyes.

The outer part structure is malleable, non-sticky, chewable, consistent and little friable with low moisture content.

Instead, the outer part or coating may comprise the following components: a cocoa butter substitute fat (CBS), powder whole milk, peanut, sodium caseinate, corn starch, lactose, malto-dextrin, saccharose, sodium chloride, a vitamin complex, ammonium phosphatide, and sodium benzoate.

Embodiments of the present invention comply with the physical properties of protection from moisture, drying and air direct contact, but with very different organoleptic characteristics from the bakery baths (salty and flavors to choose), with a similar texture to the bakery baths or chocolates.

### Basic Nutritional Aspects:

TABLE 1

| | Core | | Coating | | Core/Coating |
|---|---|---|---|---|---|
| Component | % | 0.75 | % | 0.25 | 75/25 (g) |
| Corn starch | 10.36 | 7.77 | 10.00 | 2.50 | 10.27% |
| Sodium caseinate | 15.00 | 11.25 | 10.00 | 2.50 | 13.75% |
| Saccharose | 6.04 | 4.53 | 5.00 | 1.25 | 5.78 |
| Salt | 1.73 | 1.30 | 1.00 | 0.25 | 1.55% |
| Malto-dextrin | 6.04 | 4.53 | 7.00 | 1.75 | 6.28% |
| Powder whole milk | 8.63 | 6.48 | 13.50 | 3.38 | 9.85% |
| Water | 7.77 | 5.83 | — | — | 5.83% |
| Lactose | — | — | 7.00 | 1.75 | 1.75 |
| Glucose | 21.59 | 16.19 | — | — | 16.19% |
| Sodium glutamate | 0.22 | 0.16 | — | — | 0.16% |
| APOKOL CM 80 | 10.37 | 7.78 | 32.90 | 8.23 | 16.00% |
| (CBS) | | | | | |
| Glycerin | 2.00 | 1.50 | — | — | 1.50% |
| Ammonium | 0.43 | 0.32 | 0.50 | 0.13 | 0.45% |
| phosphatide | | | | | |
| Peanut | 8.63 | 6.48 | 12.00 | 3.00 | 9.48% |
| Fried onion flavor | 0.09 | 0.06 | — | — | 0.06% |
| Vitamin complex | 1.00 | 0.75 | 1.00 | 0.25 | 1.00% |
| Sodium Benzoate | — | — | 0.10 | 0.03 | 0.03% |
| Potassium Sorbate | 0.10 | 0.08 | — | — | 0.08% |
| TOTALS | 100.00 | 75.00 | 100.00 | 25.00 | 100.00% |

TABLE 2

| | | | Reference |
|---|---|---|---|
| | Test 1* | Test 2 | Values |
| Hydrocarbons (%) | 41.69 | 46 | 40-60 |
| Proteins (%) | 16.83 | 16.6 | 15-20 |
| Total fat (%) | 23.5 | 20.7 | 15-30 |
| Moisture (%) | 10.8 | 12.7 | 10-15 |
| Caloric value (Kcal) | 445.63 | 436.7 | 500 |

TABLE 3

| Estimated ratio 75% Core/25% Bath | Values | % DV (*) |
|---|---|---|
| Energetic value (Kcal/100 g) | 441 | 22 |
| Hydrocarbons (g/100 g) | 46 | 15 |
| Fat Content (g/100 g) | 20.7 | 38 |
| Saturated fat (g/100 g) | 4.1 | 19 |
| Trans fat (g/100 g) | 3.8 | — |
| Proteins (g/100 g) | 16.6 | 23 |
| Moisture (g/100 g) | 12.7 | — |
| Total diet fiber (g/100 g) | 0.97 | 4 |
| Ashes (g/100 g) | 3 | — |
| Iron (mg/100 g) | 4.09 | 29 |
| Sodium (mg/100 g) | 881 | 37 |
| Calcium (mg/100 g) | 122 | 12 |
| Zinc (mg/100 g) | 5.46 | 79 |
| Selenium (mg/100 g) | 0.01 | 29 |
| Vitamin A (ug/100 g) (520 IU) | 156 | 26 |
| Vitamin B 1 (mg/100 g) | 0.6 | 50 |
| Vitamin B 2 (mg/100 g) | 0.4 | 31 |
| Vitamin B 6 (mg/100 g) | 0.7 | 54 |
| Vitamin B 12 - Cyanocobalamin (ug/100 g) | Less | ND |
| | than 5** | |
| Vitamin C - Ascorbic Acid (mg/100 g) | 16.7 | 38 |
| Vitamin D3 (ug/100 g) | 2.3 | 46 |
| Folic acid (mg/100 g) | 0.1 | 25 |

(*) Daily quantities based on a 2,000 kcal diet.

### EXAMPLES

Below are the details of examples of composition of the product obtained that may work with ±10% tolerances:

### Example 1

The following is an example of composition of the mixture with which the inner part or core of the snacks is produced:

| Component | % |
|---|---|
| Glucose | 21.50% |
| Sodium Caseinate | 14.60% |
| Corn starch | 10.30% |
| Cocoa Butter Substitute fat (CBS) | 10.30% |
| Powder whole milk | 8.60% |
| Peanut | 8.60% |
| Water | 7.70% |
| Malto-dextrin | 6.00% |
| Sugar | 6.00% |
| Glycerin | 2.60% |
| Salt | 1.68% |
| Vitamin complex | 1.30% |
| Ammonium phosphatide | 0.40% |
| Sodium Glutamate | 0.20% |
| Flavoring agent | 0.10% |
| Potassium Sorbate | 0.10% |
| Dyes | 0.02%. |
| TOTAL | 100.00% |

### Example 2

The following is another example of composition of the mixture with which the inner part or core of the snacks is produced:

| Component | % |
|---|---|
| Glucose | 21.50% |
| Sodium Caseinate | 14.60% |
| Native corn starch | 10.30% |
| Cocoa Butter Substitute (CBS) | 10.30% |
| Powder whole milk | 8.60% |
| Peanut | 8.60% |
| Water | 7.70% |
| Malto-dextrin | 6.00% |
| Sugar | 6.00% |
| Glycerin | 2.60% |
| Salt | 1.68% |
| Vitamin complex | 1.30% |
| Ammonium phosphatide | 0.40% |
| Sodium Glutamate | 0.20% |
| Flavoring agent | 0.10% |
| Potassium Sorbate | 0.10% |
| Dyes | 0.02%. |
| TOTAL | 100.00% |

### Example 3

The following is another example of composition of the mixture with which the inner part or core of the snacks is produced:

| Component | % |
|---|---|
| Glucose | 21.50% |
| Sodium Caseinate | 14.60% |
| Corn starch | 10.30% |
| Cocoa Butter Substitute (CBS) | 10.30% |
| Powder whole milk | 8.60% |
| Peanut | 8.60% |
| Water | 7.70% |
| Malto-dextrin | 6.00% |
| Sugar | 6.00% |
| Glycerin | 2.60% |
| Salt | 1.68% |
| Vitamin complex | 1.30% |
| Ammonium phosphatide | 0.40% |
| Sodium Glutamate | 0.20% |
| Fried onion flavor | 0.10% |
| Potassium Sorbate | 0.10% |
| Dyes | 0.02%. |
| TOTAL | 100.00% |

### Example 4

The following is another example of composition of the mixture with which the inner part or core of the snacks is produced:

| Component | % |
|---|---|
| Glucose | 21.50% |
| Sodium Caseinate | 14.60% |
| Corn starch | 10.30% |
| Cocoa Butter Substitute (CBS) | 10.30% |
| Powder whole milk | 8.60% |
| Peanut | 8.60% |
| Water | 7.70% |
| Malto-dextrin | 6.00% |
| Sugar | 6.00% |
| Glycerin | 2.60% |
| Salt | 1.68% |
| Vitamin complex | 1.30% |
| Ammonium phosphatide | 0.40% |
| Sodium Glutamate | 0.20% |
| Fried onion flavor | 0.10% |
| Potassium Sorbate | 0.10% |
| Synthetic dye | 0.01%. |
| Natural Caramel dye | 0.01%. |
| TOTAL | 100.00% |

### Example 5

The following is an example of composition of the mixture with which the outer part or coating of the snacks is produced:

| Component | % |
|---|---|
| Cocoa Butter Substitute (CBS) | 32.90% |
| Powder whole milk | 13.50% |
| Peanut | 12.00% |
| Sodium Caseinate | 10.00% |
| Corn starch | 10.00% |
| Lactose | 7.00% |
| Malto-dextrin | 7.00% |
| Saccharose | 5.00% |
| Sodium Chloride | 1.00% |
| Vitamin complex | 1.00% |
| Ammonium phosphatide | 0.50% |
| Sodium Benzoate | 0.10% |
| TOTAL | 100.00% |

### Example 6

The following is another example of composition of the mixture with which the outer part or coating of the snacks is produced:

| Component | % |
|---|---|
| Cocoa Butter Substitute (CBS) | 32.90% |
| Powder whole milk | 13.50% |
| Peanut | 12.00% |
| Sodium Caseinate | 10.00% |
| Native corn starch | 10.00% |
| Lactose | 7.00% |
| Malto-dextrin | 7.00% |
| Saccharose | 5.00% |
| Sodium Chloride | 1.00% |
| Vitamin complex | 1.00% |
| Ammonium phosphatide | 0.50% |
| Sodium Benzoate | 0.10% |
| TOTAL | 100.00% |

### Example 7

The following is an example of composition of a vitamin and mineral complex for the snacks, which dose may be 1 g per snack:

| Component | Quantity |
|---|---|
| A 500 | 0.200 |
| A/D3 500/100 | 0.050 |
| B1 | 0.053 |
| B2 | 0.020 |
| B6 | 0.075 |
| B12 (1%) | 0.008 |
| C | 2.250 |
| Folic. | 0.015 |
| ZnSO4 | 1.103 |
| Fe | 0.407 |
| Silica Col | 0.010 |
| Malto-dextrin | 95.811 |
| TOTAL | 100.00 |

Undoubtedly, upon putting the present invention into practice, modifications may be introduced regarding certain construction details and form, without leaving the essential principles that are clearly explained in the claims below:

What is claimed is:

1. A method of producing a food product having a core with an outer coating, the method comprising:
producing a first mixture of dry ingredients comprising a source of proteins, a source of hydrocarbons, a nutritional supplement and additives, wherein the first mixture of drying ingredients includes at least one ingredient that is able to reduce water activity;
producing a second mixture of liquid ingredients that has a single phase, the second mixture of liquid ingredients comprising water and a monosaccharide;
producing a third mixture by melting at a predetermined temperature a source of fat matter and mixing with at least an emulsifier/stabilizer and a flavoring agent;
producing a fourth coating mixture which is solid at room temperature and which comprises components including a source of fat matter, a source of proteins, a source of hydrocarbons, a nutritional supplement, vitamins, an emulsifier/stabilizer and a preservative, wherein at least one of the components is able to reduce water activity;
subjecting the fourth mixture to heat so as to melt the fourth mixture to produce a coating bath;
mixing the first mixture of solid ingredients, the second mixture of liquid ingredients, the third mixture, and a substitute of fats and sugars which reduces water activity and gives substance, until obtaining a malleable dough;
pouring the dough into a production line that subjects the dough to lamination, cooling and fractionation in order to produce food products; and
producing a coating bath with the fourth coating mixture over the food products resulting from the fractionation, cooling and packaging.

2. The method of claim 1, wherein for the first mixture of dry ingredients:
the source of proteins comprises sodium caseinate,
the source of hydrocarbons comprises at least one of corn starch and malto-drextin,
the nutritional supplement comprises powder whole milk,
the additives comprise flavor booster additives, preservatives and vitamins, wherein the vitamins comprise at least one of sodium glutamate, potassium sorbate and a vitamin complex.

3. The method of claim 2, wherein the first mixture of dry ingredients comprises: sodium caseinate, corn starch, powder whole milk, malto-dextrin, sodium glutamate, potassium sorbate, and a vitamin complex.

4. The method of claim 1, wherein the second mixture of dry ingredients comprises:
a solvent for solutions comprising water,
a source of hydrocarbons comprising sugar,
a flavoring agent comprising salt,
wherein the source of hydrocarbons and the flavoring agent are dissolved in the solvent to obtain a dissolution, and
the dissolution is mixed with glucose.

5. The method of claim 1, wherein for the third mixture:
the source of fat matter comprises an alternative cocoa butter, and the alternative cocoa butter is melted at a temperature not exceeding 40° C. in order to make the mixture with the rest of the components of the third mixture, and
the emulsifier/stabilizer comprises ammonium phosphatide.

6. The method of claim 1, wherein for the fourth coating mixture:
the source of fat content comprises an alternative fat of cocoa butter,
the source of proteins comprises at least one of sodium caseinate and lactose,
the source of hydrocarbons comprises at least one of corn starch, malto-dextrin and saccharose,
the nutritional supplement comprises at least one of powder whole milk and peanut,
the emulsifiers/stabilizer, the preservative and the vitamins comprise at least one of sodium chloride, ammonium phosphatide, sodium benzoate, and a vitamin complex; and
wherein the components of the fourth coating mixture further includes a flavoring additive.

7. The method of claim 6, wherein the fourth coating mixture comprises: an alternative cocoa butter fat, powder whole milk, peanut, sodium caseinate, corn starch, lactose, malto-dextrin, saccharose, sodium chloride, a vitamin complex, ammonium phosphatide and sodium benzoate.

8. The method of claim 6, wherein the coating on the outer part comprises, with a ±10% tolerance, the following components in percentages: an alternative cocoa butter fat 32.9%, powder whole milk 13.50%, peanut 12.00%, sodium caseinate 10.00%, corn starch 10.00%, lactose 7.00%, malto-dextrin 7.00%, saccharose 5.00%, sodium chloride 1.00%, a vitamin complex 1.00%, ammonium phosphatide 0.50% and sodium benzoate 0.10%.

9. The method of claim 1, wherein the inner part comprises:
a source of fat content comprising an alternative fat of cocoa butter,
a source of proteins comprising sodium caseinate,
a source of hydrocarbons comprising at least one of glucose, corn starch, malto-dextrin and sugar,
a nutritional supplement comprising at least one of powder whole milk and peanut,
flavoring additives, flavor boosters, preservatives and vitamins comprising at least one of sodium chloride, ammonium phosphatide, sodium glutamate, potassium sorbate and a vitamin complex and
at least one ingredient able to reduce water activity.

10. The method of claim 1, wherein the inner part comprises: glucose, sodium caseinate, corn starch, an alternative cocoa butter fat, powder whole milk, peanut, water, malto-dextrin, sugar, glycerin, salt, a vitamin complex, ammonium phosphatide, sodium glutamate, flavoring agent, potassium sorbate and dyes.

11. The method of claim 1, wherein the inner part comprises, with a ±10% tolerance, the following components in percentages: glucose 21.50%, sodium caseinate 14.60%, corn starch 10.30%, an alternative cocoa butter fat 10.30%, powder whole milk 8.60%, peanut 8.60%, water 7.70%, malto-dextrin 6.00%, sugar 6.00%, glycerin 2.60%, salt 1.68%, a vitamin complex 1.30%, ammonium phosphatide 0.40%, sodium glutamate 0.20%, flavoring agent 0.10%, potassium sorbate 0.10% and dyes 0.02%.

12. The method of claim 1, wherein at least one of the source of fat matter of the third mixture and the source of fat matter of the fourth coating mixture comprises a cocoa butter substitute.

13. The method of claim 1, wherein at least one of the source of hydrocarbons of the first mixture and the source of hydrocarbons of the fourth coating mixture comprises native corn starch.

14. The method of claim 1, wherein at least one of the first mixture, the second mixture, the third mixture, the fourth mixture and the mixing of the first through four mixtures is performed using a double “Z” mixer.

15. The method of claim 1, wherein when producing the coating bath, the coating mixture is arranged in a bathing device at a temperature of about 40° C.

16. The method of claim 1, wherein after the fractionation of the dough forming the cores of the food products, the resulting food products pass beneath the coating bath arranged above the production line, at which exit, there is a cooling device.

17. The method of claim 1, wherein, during the producing the coating bath, after mixing the fourth coating mixture and prior to the fourth coating mixture's arrangement in a bathing device, the fourth coating mixture is subject to refinement and conching.

18. A food product comprising:
an inner part or core comprising the product of a mixture of glucose, sodium caseinate, corn starch, a cocoa butter substitute (CBS) fat, powder whole milk, peanut, water, malto-dextrin, sugar, glycerin, salt, a vitamin complex, ammonium phosphatide, sodium glutamate, flavoring agent, potassium sorbate, and dyes; and
an outer part or coating comprising the product of a mixture of a cocoa butter substitute (CBS), powder whole milk, peanut, sodium caseinate, corn starch, lactose, malto-dextrin, saccharose, sodium chloride, a vitamin complex, ammonium phosphatide, and sodium benzoate.

19. The food product of claim 18, wherein:
for the inner part or core, with a ±10% tolerance, the mixture is glucose 21.50%, sodium caseinate 14.60%, corn starch 10.30%, a cocoa butter substitute (CBS) fat 10.30%, powder whole milk 8.60%, peanut 8.60%, water 7.70%, malto-dextrin 6.00%, sugar 6.00%, glycerin 2.60%, salt 1.68%, a vitamin complex 1.30%, ammonium phosphatide 0.40%, sodium glutamate 0.20%, flavoring agent 0.10%, potassium sorbate 0.10%, and dyes 0.02% and
for the outer part or coating, with a ±10% tolerance: the mixture is a cocoa butter substitute (CBS) fat 32.90%, powder whole milk 13.50%, peanut 12.00%, sodium caseinate10.00%, corn starch 10.00%, lactose 7.00%, malto-dextrin 7.00%, saccharose 5.00%, sodium chloride 1.00%, a vitamin complex 1.00%, ammonium phosphatide 0.50%, and sodium benzoate 0.10%.

20. The food product of claim 18, wherein, with a ±20% tolerance, the inner part constitutes 75% of the food product, whereas the outer part constitutes 25% of the food product.
